(19) United States
(12) Patent Application Publication
(10) Pub. No.: US 2022/0015592 A1
(43) Pub. Date: Jan. 20, 2022

(54) VACUUM CLEANER, VACUUM CLEANER SYSTEM, AND CLEANING CONTROL PROGRAM

(71) Applicant: PANASONIC INTELLECTUAL PROPERTY MANAGEMENT CO., LTD., Osaka (JP)

(72) Inventors: Yasunari IGUCHI, Osaka (JP); Yuta MIURA, Osaka (JP); Yuko TSUSAKA, Kyoto (JP)

(21) Appl. No.: 17/375,946

(22) Filed: Jul. 14, 2021

(30) Foreign Application Priority Data
Jul. 20, 2020 (JP) 2020-123515

(51) Int. Cl. A47L 9/00; A47L 9/28; G05D 1/02

(52) U.S. Cl. CPC A47L 9/009; A47L 9/2805; A47L 9/2852; G05D 2201/0215; G05D 1/0219; A47L 2201/04; G05D 1/0274

(57) ABSTRACT

A vacuum cleaner autonomously runs in a predetermined space and performs cleaning. This vacuum cleaner includes a position sensor that acquires a positional relationship between the vacuum cleaner and an object present in a two-dimensional measurement target space along a running surface of the vacuum cleaner, an estimated map acquisition unit that acquires a self-position estimation map corresponding to the measurement target space, a cleaning route acquisition unit that acquires a cleaning route created along the running surface based on a route planning map having a shape different from a shape of the self-position estimation map, a self-position estimation unit that estimates the self-position using the positional relationship based on the position sensor and the self-position estimation map, and a running controller that causes the vacuum cleaner to run along the cleaning route based on the self-position estimated by the self-position estimation unit.

### BACKGROUND

### 1. Technical Field

The present disclosure relates to a vacuum cleaner that performs cleaning while autonomously running, a vacuum cleaner system including the plurality of vacuum cleaners, and a cleaning control program for controlling the vacuum cleaner.

### 2. Description of the Related Art

Conventionally, there is a self-propelled robot. The self-propelled robot scans a laser distance sensor called light detection and ranging (LiDAR) in a horizontal plane, senses the position of an object present around the robot and the distance to the object, grasps the position of the robot (hereinafter, also referred to as self-position), and autonomously runs.

JP 2017-102705 A (to be referred to as “Patent Literature 1” hereinafter) discloses a self-propelled robot including a device that moves a laser distance sensor in a height direction. By sensing surrounding objects at a plurality of height positions, the self-propelled robot can improve estimation accuracy of the self-position.

On the other hand, in many cases, the vacuum cleaner does not include a mechanism for moving the sensor up and down. Providing a mechanism for moving the sensor up and down for the vacuum cleaner leads to an increase in weight of the vacuum cleaner, and further requires time to move the sensor up and down while the vacuum cleaner is performing cleaning, resulting in deterioration in cleaning efficiency.

However, in a case where the height position of the sensor included in the vacuum cleaner is constant, when there is an obstacle on the floor surface that is not detected by the sensor but becomes an obstacle to the running of the vacuum cleaner, a mismatch sometimes occurs between the information obtained by the sensor and the range where the vacuum cleaner can actually run, and the entire floor surface sometimes cannot be appropriately cleaned.

### SUMMARY

The present disclosure provides a vacuum cleaner, a vacuum cleaner system, and a cleaning control program that can appropriately clean a floor surface based on a plurality of maps having different shapes.

The present disclosure provides a vacuum cleaner that autonomously runs and cleans a predetermined space. This vacuum cleaner includes a position sensor that acquires a positional relationship between the vacuum cleaner and an object present in a two-dimensional measurement target space along a running surface of the vacuum cleaner, an estimated map acquisition unit that acquires a self-position estimation map corresponding to the measurement target space, a cleaning route acquisition unit that acquires a cleaning route created along the running surface based on a route planning map having a shape different from a shape of the self-position estimation map, a self-position estimation unit that estimates the self-position using the positional relationship based on the position sensor and the self-position estimation map, and a running controller that causes the vacuum cleaner to run along the cleaning route based on the self-position estimated by the self-position estimation unit.

The present disclosure is a vacuum cleaner system including at least two vacuum cleaners each including a position sensor that acquires a positional relationship between the vacuum cleaner and an object present in a two-dimensional measurement target space along a running surface of the vacuum cleaner, an estimated map acquisition unit that acquires a self-position estimation map corresponding to the measurement target space, a cleaning route acquisition unit that acquires a cleaning route created along the running surface based on a route planning map having a shape different from a shape of the self-position estimation map, a self-position estimation unit that estimates the self-position using the positional relationship based on the position sensor and the self-position estimation map, and a running controller that causes the vacuum cleaner to run along the cleaning route based on the self-position estimated by the self-position estimation unit. In this vacuum cleaner system, at least one of the vacuum cleaners is a high vacuum cleaner, an allowable height that allows the high vacuum cleaner to enter for cleaning is relatively high, and at least one of remaining vacuum cleaners of the vacuum cleaners is a low vacuum cleaner, an allowable height that allows the low vacuum cleaner to enter for cleaning is lower than the allowable height allowing the high vacuum cleaner to enter. A high cleaning route which is a cleaning route acquired by the cleaning route acquisition unit of the high vacuum cleaner is different from a low cleaning route which is a cleaning route acquired by the cleaning route acquisition unit of the low vacuum cleaner.

The present disclosure provides a cleaning control program for controlling a vacuum cleaner that autonomously runs and cleans a predetermined space. This cleaning control program causes a computer to implement an estimated map acquisition unit that acquires a self-position estimation map corresponding to the measurement target space, a cleaning route acquisition unit that acquires a cleaning route created along the running surface based on a route planning map having a shape different from a shape of the self-position estimation map, a self-position estimation unit that acquires, from a position sensor, a positional relationship between the vacuum cleaner and an object present in a two-dimensional measurement target space along a running surface of the vacuum cleaner and estimates the self-position using the acquired positional relationship and the self-position estimation map, and a running controller that causes the vacuum cleaner to run along the cleaning route based on the self-position estimated by the self-position estimation unit. The cleaning control program is stored in a non-transitory computer-readable storage medium.

According to the present disclosure, since the cleaning route based on the route plan creation map and the self-position estimation map are stored separately, it is possible to provide a vacuum cleaner, a vacuum cleaner system, and a cleaning control program that can perform cleaning based on the cleaning route for an area that the vacuum cleaner can actually clean while correctly recognizing the self-position.

### BRIEF DESCRIPTION OF THE DRAWINGS

FIG. 1 is a perspective view illustrating a vacuum cleaner system according to an exemplary embodiment together with an example of a section to be cleaned;

FIG. 2 is a block diagram illustrating a configuration of the vacuum cleaner system according to the exemplary embodiment;

FIG. 3 is a sectional view illustrating an example of a section where the vacuum cleaner system according to the exemplary embodiment cleans when viewed from a side;

FIG. 4 is a diagram illustrating an example of a self-position estimation map and an example of a route planning map according to the exemplary embodiment;

FIG. 5 is a diagram illustrating an example of a high plan map and an example of a high cleaning route in an overlapping state according to the exemplary embodiment;

FIG. 6 is a diagram illustrating an example of a low plan map and an example of a low cleaning route in an overlapping state according to the exemplary embodiment;

FIG. 7 is a perspective view illustrating an example of a section where a glass showcase according to another example 1 is placed on a running surface;

FIG. 8 is a diagram illustrating an example of a self-position estimation map according to another example 1;

FIG. 9 is a diagram illustrating an example of a route planning map and an example of a cleaning route in another example 1 in an overlapping state;

FIG. 10 is a block diagram illustrating a configuration of a vacuum cleaner according to another example 2; and

FIG. 11 is a sectional view illustrating an example of a section where a vacuum cleaner system according to another example 3 performs cleaning when viewed from a side.

### DETAILED DESCRIPTION

An exemplary embodiment of a vacuum cleaner, a vacuum cleaner system and a cleaning control program according to the present disclosure will be described below with reference to the drawings. Numerical values, shapes, materials, components, the positional relationship between constituent elements, connection states of the constituent elements, steps, the orders of steps, and the like, to be used in the following exemplary embodiments are exemplary and are not to limit the scope of the present disclosure. Further, in the following, a plurality of disclosures may be described as one embodiment, but constituent elements not described in the claims are described as arbitrary constituent elements in the disclosures according to the claims. In addition, the drawings are schematic views in which emphasis, omission, and ratio adjustment are appropriately performed in order to describe the present disclosure, and may be different from actual shapes, positional relationships, and ratios.

In addition, a description more detailed than necessary may be omitted. For example, the detailed description of already well-known matters or the overlap description of substantially same configurations may be omitted. This is to avoid an unnecessarily redundant description below and to facilitate understanding of a person skilled in the art.

Note that the attached drawings and the following description are provided for those skilled in the art to fully understand the present disclosure, and are not intended to limit the subject matter as described in the appended claims.

### Exemplary Embodiment

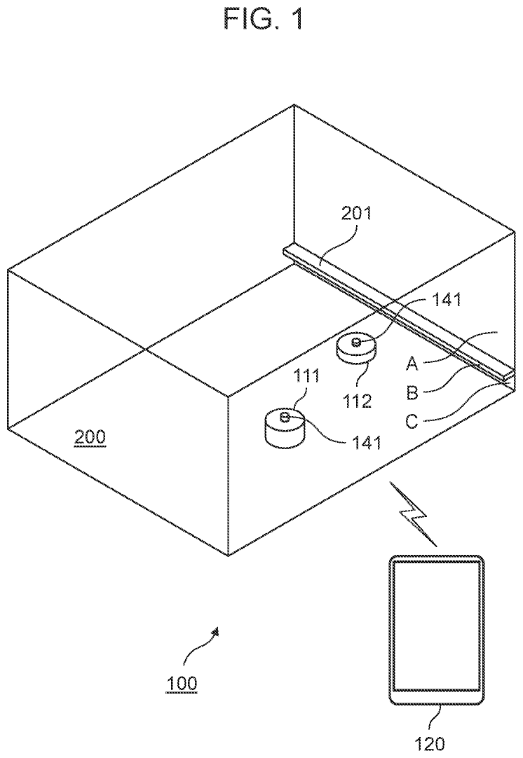

A vacuum cleaner, vacuum cleaner system and a cleaning control program according to an exemplary embodiment of the present disclosure will be described below with reference to FIGS. 1 to 6.

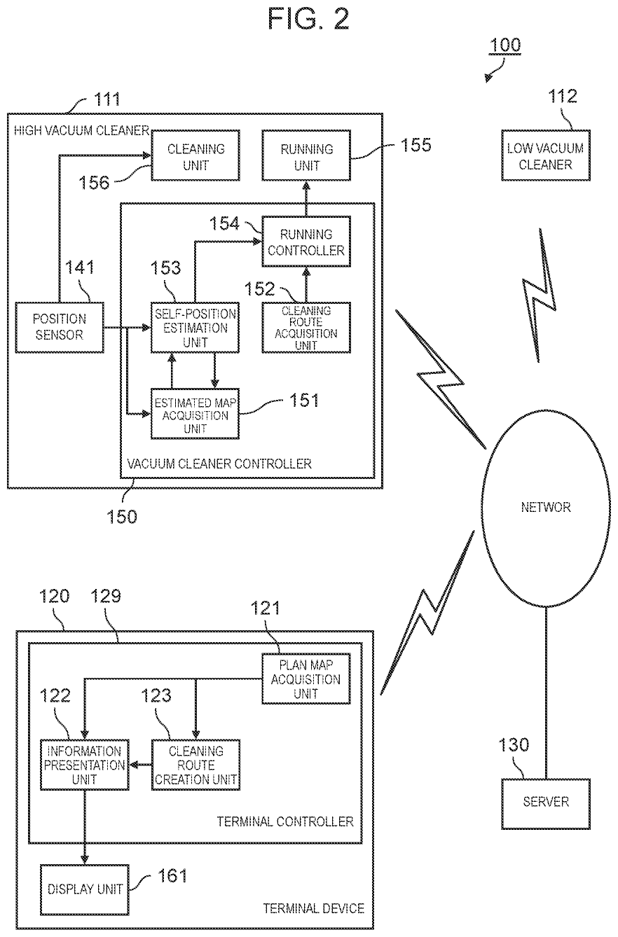

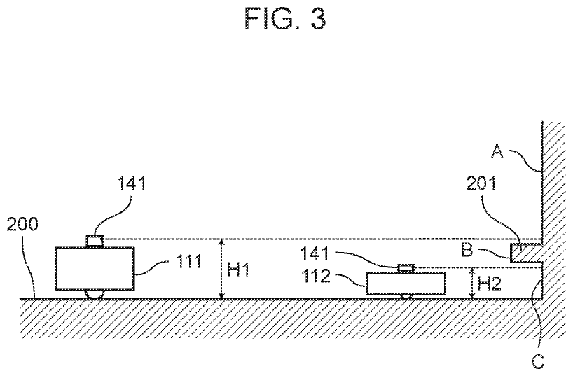

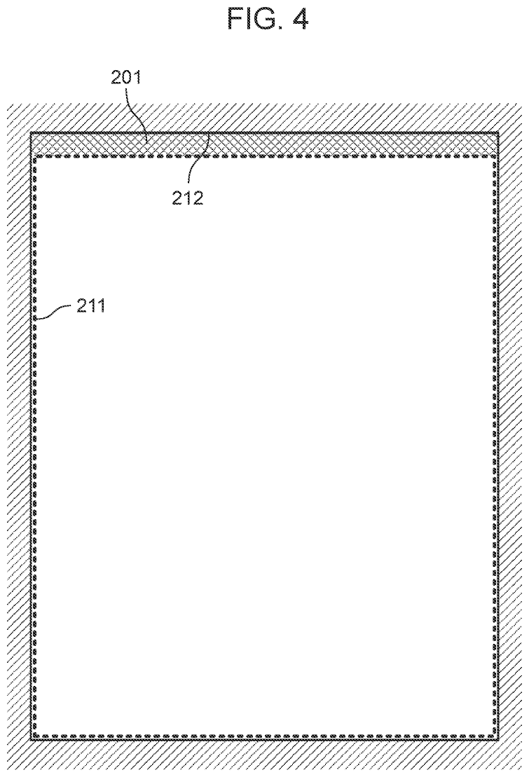

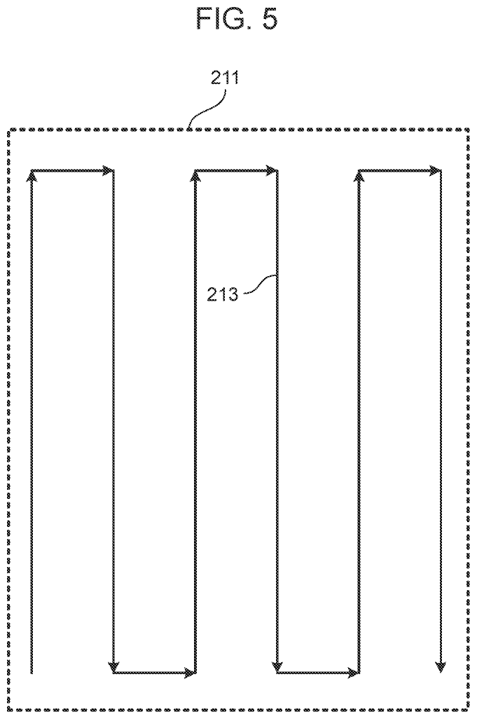

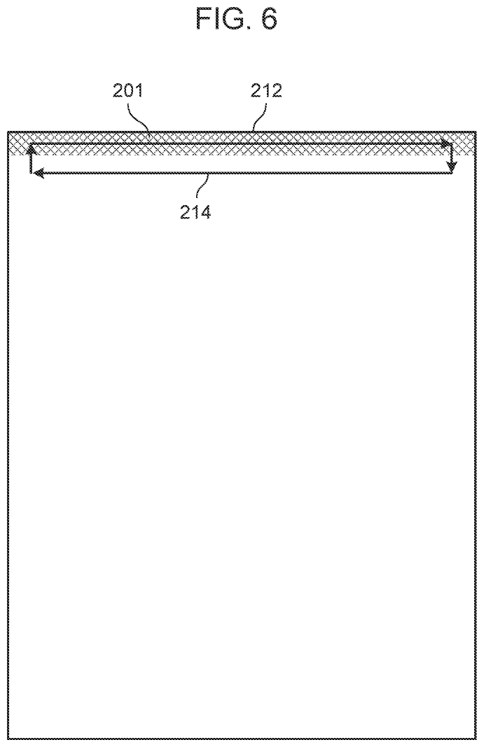

FIG. 1 is a perspective view illustrating vacuum cleaner system 100 according to an exemplary embodiment together with an example of a section to be cleaned. FIG. 2 is a block diagram illustrating the configuration of vacuum cleaner system 100 according to the exemplary embodiment. FIG. 3 is a cross-sectional view illustrating an example of a section where vacuum cleaner system 100 according to the exemplary embodiment performs cleaning from a side. FIG. 4 is a diagram illustrating an example of a self-position estimation map and an example of a route planning map according to the exemplary embodiment. FIG. 5 is a diagram illustrating an example of a high plan map and an example of a high cleaning route in an overlapping manner according to the exemplary embodiment. FIG. 6 is a diagram illustrating an example of a low plan map and an example of a low cleaning route in an overlapping manner according to the exemplary embodiment.

Vacuum cleaner system 100 is a system including a plurality of vacuum cleaners 110 that autonomously run to clean running surface 200. At least one of the vacuum cleaners 110 is high vacuum cleaner 111 having a height higher than that of low vacuum cleaner 112, and at least the other one is low vacuum cleaner 112 having a height lower than that of high vacuum cleaner 111. In vacuum cleaner system 100, high vacuum cleaner 111 and low vacuum cleaner 112 can clean running surface 200 by cooperation. In the present exemplary embodiment, vacuum cleaner 110 is used as a generic term of high vacuum cleaner 111 and low vacuum cleaner 112. Therefore, vacuum cleaner 110 may be read as high vacuum cleaner 111 or low vacuum cleaner 112. The present exemplary embodiment will exemplify a configuration in which vacuum cleaner system 100 includes one high vacuum cleaner 111 and one low vacuum cleaner 112. However, the exemplary embodiment may include a plurality of high vacuum cleaners 111 and a plurality of low vacuum cleaners 112. In the present exemplary embodiment, vacuum cleaner system 100 includes terminal device 120. Vacuum cleaner 110 and terminal device 120 can perform information communication with server 130 via a network. Vacuum cleaner 110 and terminal device 120 may directly communicate with each other without going through a network.

FIG. 3 is a sectional view illustrating an example of a section where vacuum cleaner system 100 performs cleaning when viewed from a side. In the example illustrated in FIG. 3, protrusion 201 is present on the wall of the section to be cleaned. Protrusion 201 protrudes from running surface 200 at a predetermined height position. However, in this section, low vacuum cleaner 112 is lower in height than protrusion 201, and hence can run below protrusion 201 to reach wall surface C. In contrast, in this section, high vacuum cleaner 111 is higher than protrusion 201 and interferes with protrusion 201, and hence cannot reach wall surfaces A and C.

Terminal device 120 includes a communication device (not illustrated) that acquires information from vacuum cleaner 110, and processes the information acquired by the communication device. Terminal device 120 includes display unit 161 that can display the processed information to the user and terminal controller 129. As terminal device 120, for example, a so-called smartphone, a so-called tablet, a so-called notebook personal computer, a so-called desktop personal computer, or the like can be exemplified. Terminal device 120 includes plan map acquisition unit 121, cleaning route creation unit 123, and information presentation unit 122 as processing units implemented by executing programs in a processor (not illustrated) included in terminal controller 129.

Plan map acquisition unit 121 acquires a route planning map for planning a route on which vacuum cleaner 110 runs. The type of map acquired by plan map acquisition unit 121 and the acquisition destination of the map are not particularly limited. For example, plan map acquisition unit 121 may acquire a floor map including the cleaning target area of vacuum cleaner 110 from server 130 via a network and create a route planning map on the basis of the floor map. In addition, plan map acquisition unit 121 may receive creation or change of a route plan map based on a user's input to terminal device 120. In addition, plan map acquisition unit 121 may cause vacuum cleaner 110 to perform test running for the purpose of acquiring a map, and acquire a route planning map from vacuum cleaner 110. Note that a map in this case is information or data representing a map that can be processed by the processor, and a map as a visually recognizable graphic created on the basis of this information or data is displayed on display unit 161. In the present exemplary embodiment, information or data representing a map that can be processed by the processor and a map as a visually recognizable graphic are not particularly distinguished and are both displayed as maps.

A case in which plan map acquisition unit 121 acquires a floor map illustrated in FIG. 4 will be described here. It is assumed that the floor map acquired by plan map acquisition unit 121 is, for example, the rectangle indicated by the solid line in FIG. 4 and includes information on protrusion 201 indicated by the cross hatching in FIG. 4. At this time, if the height of low vacuum cleaner 112 is lower than the protruding position of protrusion 201, the user can register a rectangle represented by a solid line including an area immediately below protrusion 201 as low plan map 212 which is a route planning map for low vacuum cleaner 112. When the user registers low plan map 212, plan map acquisition unit 121 acquires information representing low plan map 212. In addition, if high vacuum cleaner 111 has a height higher than or equal to the protruding position of protrusion 201, the user can create a map avoiding protrusion 201 indicated by the dashed rectangle in FIG. 4 and register the map as high plan map 211 which is a route planning map for high vacuum cleaner 111. When the user registers high plan map 211, plan map acquisition unit 121 acquires information representing high plan map 211.

Cleaning route creation unit 123 creates a cleaning route indicating a running route on which vacuum cleaner 110 should run for cleaning based on the route planning map acquired by plan map acquisition unit 121. Cleaning route creation unit 123 may automatically create a cleaning route or may receive creation or change of the cleaning route based on a user's input to terminal device 120. In addition, the cleaning route may include information indicating a cleaning method, such as controlling the strength of suction force in a state of being associated with the route.

In the present exemplary embodiment, as illustrated in FIG. 5, cleaning route creation unit 123 creates high cleaning route 213 based on high plan map 211. High plan map 211 is a route planning map showing an area where high vacuum cleaner 111 can reach. High cleaning route 213 is a cleaning route on which high vacuum cleaner 111 runs and performs cleaning. In addition, as illustrated in FIG. 6, cleaning route creation unit 123 creates low cleaning route 214 based on low plan map 212. Low plan map 212 is a route planning map showing an area where low vacuum cleaner 112 can reach. Low cleaning route 214 is a cleaning route on which low vacuum cleaner 112 runs and performs cleaning. Note that low cleaning route 214 is created as a route using the characteristics of low vacuum cleaner 112. High cleaning route 213 is created as a route using the characteristics of high vacuum cleaner 111. In the present exemplary embodiment, low vacuum cleaner 112 has characteristics of having a relatively low height and being capable of passing below projection 201. Therefore, low cleaning route 214 along which low vacuum cleaner 112 intensively cleans the lower side of protrusion 201 and its periphery is created using the characteristics. In addition, high vacuum cleaner 111 has characteristics of having a relatively high height, allowing mounting of a high-capacity battery, and being capable of cleaning a wide range. Therefore, by using these characteristics, high cleaning route 213 is created along which high vacuum cleaner 111 cleans entire running surface 200 other than the lower side of protrusion 201.

Information presentation unit 122 superimposes the cleaning route created by cleaning route creation unit 123 or the actual cleaning route of vacuum cleaner 110, along which vacuum cleaner 110 has actually cleaned, on the route plan map acquired by plan map acquisition unit 121 and presents the superimposed route plan map to display unit 161. In the present exemplary embodiment, information presentation unit 122 can selectively display, on display unit 161, the image obtained by superimposing high plan map 211 and high cleaning route 213 as illustrated in FIG. 5 or the image obtained by superimposing low plan map 212 and low cleaning route 214 as illustrated in FIG. 6.

Vacuum cleaner 110 is a so-called robot vacuum cleaner that autonomously runs and cleans a predetermined space. Note that the basic functions and configurations of high vacuum cleaner 111 and low vacuum cleaner 112 are the same as each other. Therefore, vacuum cleaner 110 or high vacuum cleaner 111 will be described here, and a description of low vacuum cleaner 112 will be omitted. Different configurations between high vacuum cleaner 111 and low vacuum cleaner 112 will be appropriately described as necessary. High vacuum cleaner 111 and low vacuum cleaner 112 each include position sensor 141 and vacuum cleaner controller 150 that controls running and cleaning of vacuum cleaner 110. In the present exemplary embodiment, vacuum cleaner 110 includes running unit 155, vacuum cleaner 156, and a communication device (not shown).

Position sensor 141 is a sensor that acquires the positional relationship between vacuum cleaner 110 and an object present in a two-dimensional measurement target space substantially parallel to a running surface on which vacuum cleaner 110 autonomously runs and executes cleaning. In this case, an object is an object that can be sensed by position sensor 141. Objects include fixed objects such as a wall of a building and movable objects such as a chair, a table, and a sofa. Depending on the type of position sensor 141, glass or the like may not be sensed, and an object that cannot be sensed may be excluded from objects.

The type of position sensor 141 is not particularly limited as long as it can acquire a relative positional relationship including the distance between vacuum cleaner 110 and an object present around vacuum cleaner 110.

Vacuum cleaner 110 may include a plurality of types of sensors having different functions as position sensor 141. Specifically, as position sensor 141, an ultrasonic sensor, a LiDAR sensor, an RGB camera, a DEPTH camera, an infrared distance measuring sensor, a wheel odometry, a gyro sensor, and the like can be exemplified. In the present exemplary embodiment, vacuum cleaner 110 includes, as one of position sensors 141, 2D-LiDAR that acquires the position of and the distance to an object around vacuum cleaner 110 in one plane.

As illustrated in FIG. 3, position sensor 141 included in high vacuum cleaner 111 can measure the distance to the object by emitting a laser beam passing through the plane of first height H1 from running surface 200 and receiving the laser beam reflected onto the object. Furthermore, position sensor 141 can also measure the position of the object with respect to high vacuum cleaner 111 by rotating a laser beam in a plane parallel to running surface 200 and measuring the distance to the object at every predetermined angle. Position sensor 141 included in low vacuum cleaner 112 has the same function as position sensor 141 included in high vacuum cleaner 111, and emits laser beam passing through a plane at second high H2 from running surface 200.

Vacuum cleaner controller 150 includes a processor (not illustrated) and implements each processing unit by executing a cleaning control program using the processor. Vacuum cleaner controller 150 implements estimated map acquisition unit 151, cleaning route acquisition unit 152, self-position estimation unit 153, and a running controller 154 as processing units.

Estimated map acquisition unit 151 acquires a self-position estimation map corresponding to a measurement target space. The measurement target space is a space where position sensor 141 can measure the position of the object and the distance to the object. Estimated map acquisition unit 151 may acquire a self-position estimation map from terminal device 120, server 130, or the like. In the present exemplary embodiment, estimated map acquisition unit 151 creates a self-position estimation map regarding the surrounding environment of vacuum cleaner 110 parallel to running surface 200 at the height position of position sensor 141 by, for example, the simultaneous localization and mapping (SLAM) technology on the basis of the information acquired from position sensor 141.

Specifically, in the measurement target space of position sensor 141 attached to high vacuum cleaner 111, estimated map acquisition unit 151 implemented by vacuum cleaner controller 150 of high vacuum cleaner 111 creates a high movement map, which is a self-position estimation map corresponding to the surface of first high H1 from running surface 200, as illustrated in FIG. 3. In the example illustrated in FIG. 3, since protrusion 201 is not included in the measurement target space indicated by the broken line, estimated map acquisition unit 151 creates information indicated by the solid rectangle in FIG. 4 as a high movement map. In the examples illustrated in FIGS. 3 and 4, the high movement map and low plan map 212 substantially coincide with each other. Note that this substantial coincidence includes a difference due to an error or the like.

In addition, in the measurement target space of position sensor 141 attached to low vacuum cleaner 112, estimated map acquisition unit 151 implemented by vacuum cleaner controller 150 of low vacuum cleaner 112 creates a low movement map, which is a self-position estimation map corresponding to the surface of second height H2 from running surface 200, as illustrated in FIG. 3. In the example illustrated in FIG. 3, since protrusion 201 is not included in the measurement target space of low vacuum cleaner 112 indicated by the broken line, estimated map acquisition unit 151 creates a low movement map similar to the high movement map indicated by the solid line in FIG. 4.

Note that vacuum cleaner 110 may create a self-position estimation map by adding information from a wheel odometry, a gyro sensor, or the like that is another sensor to the sensing information obtained by 2D-LiDAR that is position sensor 141.

Self-position estimation unit 153 estimates a self-position using the positional relationship acquired from position sensor 141, that is, the positional relationship between the object present in a measurement target space and the self-position acquired by position sensor 141 and the self-position estimation map acquired by estimated map acquisition unit 151. In the present exemplary embodiment, self-position estimation unit 153 estimates a self-position using SLAM. That is, estimated map acquisition unit 151 and self-position estimation unit 153 create a self-position estimation map while estimating a self-position using SLAM and sequentially update the self-position and the self-position estimation map.

Cleaning route acquisition unit 152 acquires the cleaning route created by cleaning route creation unit 123 along running surface 200 based on the route planning map acquired by plan map acquisition unit 121. The route planning map is different in shape from the self-position estimation map created and acquired by estimated map acquisition unit 151. In the present exemplary embodiment, cleaning route acquisition unit 152 of high vacuum cleaner 111 acquires high cleaning route 213 created by cleaning route creation unit 123 of terminal device 120, whereas cleaning route acquisition unit 152 of low vacuum cleaner 112 acquires low cleaning route 214 created by cleaning route creation unit 123 of terminal device 120.

Note that cleaning route acquisition unit 152 may acquire a route planning map, and create and acquire a cleaning route based on the acquired route planning map.

Running controller 154 causes vacuum cleaner 110 to run along the cleaning route based on the self-position estimated by self-position estimation unit 153. When the sensor acquires information indicating that an object or the like is present on the running route, running controller 154 controls running unit 155 to cause the vacuum cleaner to run while avoiding the object.

Running unit 155 includes wheels and a motor for causing vacuum cleaner 110 to run. In addition, an encoder that functions as a wheel odometry sensor and acquires the rotation angle of the motor may be attached to running unit 155.

Cleaning unit 156 is controlled by a cleaning controller (not illustrated) to perform cleaning. The type of cleaning unit 156 is not particularly limited. For example, when vacuum cleaner 110 is configured to perform suction-type cleaning, vacuum cleaning unit 156 includes a suction motor for suction, a side brush that rotates on a side of a suction port to collect dust, and a brush motor that rotates the side brush. When vacuum cleaner 110 is configured to perform wiping-type cleaning, vacuum cleaning unit 156 includes a cloth or mop for wiping and a wiping motor for operating the cloth or mop. Note that cleaning unit 156 may be configured to implement both suction-type cleaning and wiping-type cleaning.

Server 130 can communicate with vacuum cleaner 110 and terminal device 120 via a network to transmit and receive information. In the present exemplary embodiment, server 130 can communicate with each of the plurality of vacuum cleaners 110 including high vacuum cleaner 111 and low vacuum cleaner 112, and acquires information from the plurality of vacuum cleaners 110 to perform management. Furthermore, server 130 may collect and manage floor maps of residences, apartments, hotels, tenants, and the like.

As described above, according to vacuum cleaner system 100 according to the present exemplary embodiment, while estimating the self-position according to the self-position estimation map, vacuum cleaner 110 can run according to the cleaning route created based on the route planning map having a shape different from that of the self-position estimation map and perform cleaning. As a result, vacuum cleaner 110 can perform appropriate cleaning by passing through an appropriately prepared cleaning route while accurately recognizing the self-position.

Further, vacuum cleaner system 100 can clean an area corresponding to the characteristics of each of vacuum cleaners 110 by using the vacuum cleaners 110 having different characteristics. As a result, the plurality of vacuum cleaners 110 having different characteristics can automatically perform cleaning while reducing blind spots that cannot be cleaned.

Note that the present invention is not limited to the above exemplary embodiment. For example, another exemplary embodiment implemented by arbitrarily combining the constituent elements described in the present specification or excluding some of the constituent elements may be an exemplary embodiment of the present invention. The present invention also includes modifications obtained by making various modifications conceivable by those skilled in the art without departing from the spirit of the present invention, that is, the meaning indicated by the wording described in the claims.

For example, in the above exemplary embodiment, vacuum cleaner system 100 including the plurality of vacuum cleaners 110 having different functions has been described. However, it is also possible to configure vacuum cleaner system 100 such that one vacuum cleaner 110 executes cleaning.

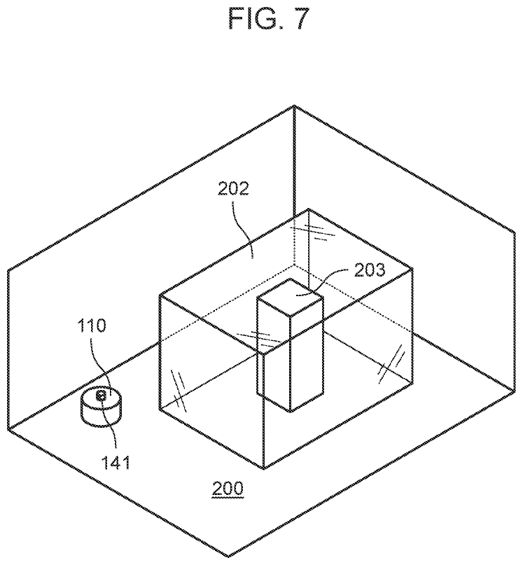

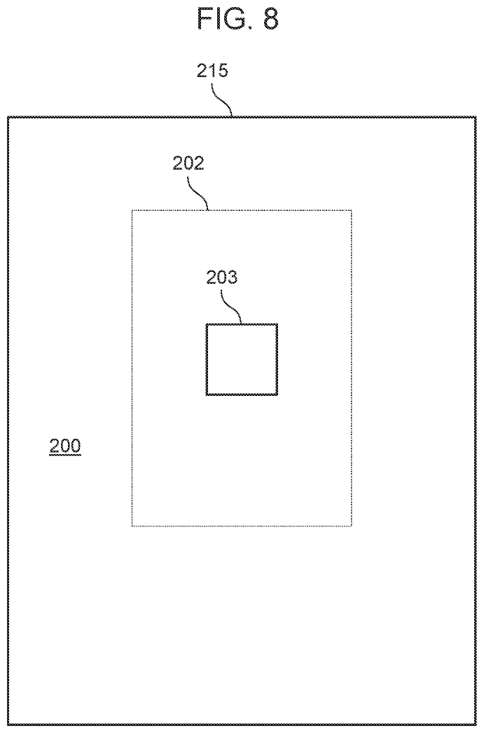

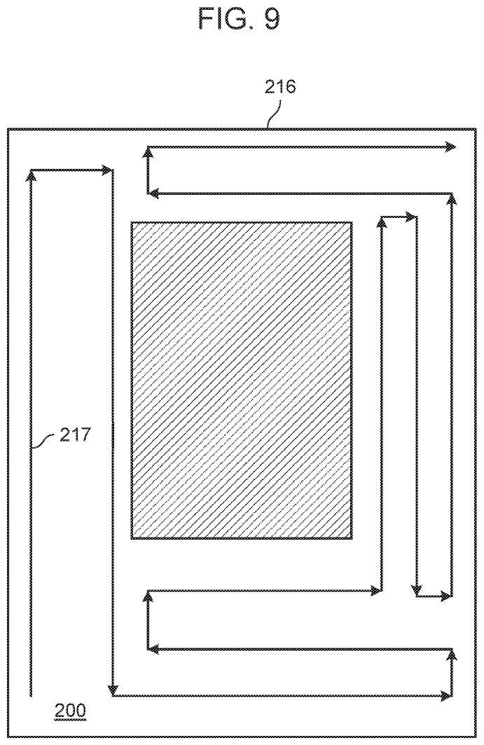

FIG. 7 is a perspective view illustrating an example of a section where glass showcase 202 according to another example 1 is placed on running surface 200. FIG. 8 is a diagram illustrating an example of a self-position estimation map according to another example 1. FIG. 9 is a diagram illustrating an example of a route planning map and an example of a cleaning route according to another example 1 in an overlapping state.

In the example illustrated in FIG. 7, glass showcase 202 is placed on running surface 200, and object 203 exists in showcase 202. In such a case, vacuum cleaner 110 cannot enter showcase 202. However, there is a case in which a laser beam emitted from position sensor 141 included in vacuum cleaner 110 passes through showcase 202 and position sensor 141 cannot detect showcase 202. In such a case, as the self-position estimation map acquired by estimated map acquisition unit 151, a self-position estimation map 215 including object 203 and a wall surface, excluding showcase 202, as indicated by the solid line in FIG. 8 is created.

On the other hand, cleaning route acquisition unit 152 of vacuum cleaner 110 acquires cleaning route 217 created on the basis of route planning map 216, illustrated in FIG. 9, having a different shape from self-position estimation map 215 illustrated in FIG. 8, that is, route planning map 216 having running surface 200 between showcase 202 and the wall surface. Note that vacuum cleaner 110 may create route planning map 216 by itself or may acquire route planning map 216 from an external device such as terminal device 120. Cleaning route acquisition unit 152 may create cleaning route 217 by itself.

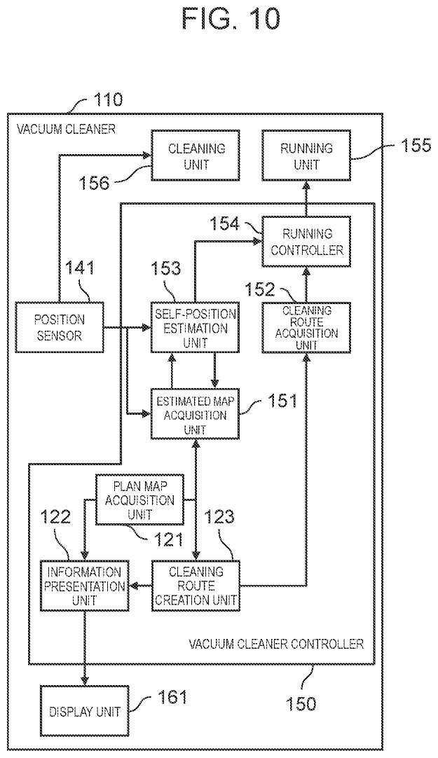

In addition, in the above-described exemplary embodiment, the configuration in which each processing unit implemented by executing programs by the processor is divided into autonomous running vacuum cleaner 110 and terminal device 120 has been described. However, which of the processing units is implemented by vacuum cleaner 110 and which is implemented by terminal device 120 is arbitrary. FIG. 10 is a block diagram illustrating a configuration of vacuum cleaner 110 according to another example 2. For example, as illustrated in FIG. 10, the respective processing units may be integrated into vacuum cleaner 110 including display unit 161.

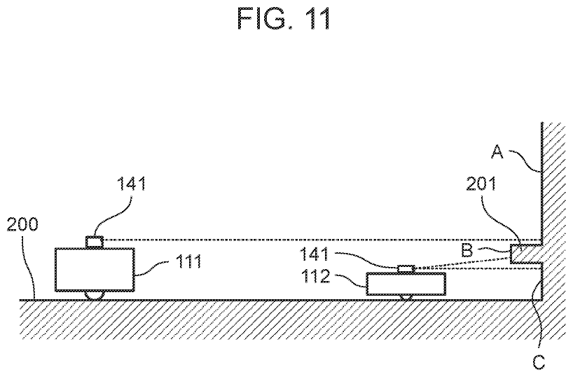

FIG. 11 is a sectional view illustrating an example of a section where vacuum cleaner system 100 according to another example 3 performs cleaning when viewed from a side. For example, as illustrated in FIG. 11, position sensor 141 included in at least one of the plurality of vacuum cleaners 110 (in the example illustrated in FIG. 11, low vacuum cleaner 112) may detect an object at a plurality of points in the height direction. In such a case, vacuum cleaner 110 may create a route planning map used for another vacuum cleaner 110 (for example, high vacuum cleaner 111).

The present disclosure is applicable to a robot vacuum cleaner that autonomously runs and performs cleaning and a vacuum cleaner system including a plurality of robot vacuum cleaners.

What is claimed is:

1. A vacuum cleaner that autonomously runs in a predetermined space and performs cleaning, the vacuum cleaner comprising:
a position sensor that acquires a positional relationship between the vacuum cleaner and an object present in a two-dimensional measurement target space along a running surface of the vacuum cleaner;
an estimated map acquisition unit that acquires a self-position estimation map corresponding to the measurement target space;
a cleaning route acquisition unit that acquires a cleaning route created along the running surface based on a route planning map having a shape different from a shape of the self-position estimation map,
a self-position estimation unit that estimates a self-position using the positional relationship based on the position sensor and the self-position estimation map; and
a running controller that causes the vacuum cleaner to run along the cleaning route based on the self-position estimated by the self-position estimation unit.

2. A vacuum cleaner system comprising a plurality of vacuum cleaners including vacuum cleaners each being the vacuum cleaner according to claim 1,
wherein at least one of the vacuum cleaners is a high vacuum cleaner, an allowable height allowing the high vacuum cleaner to enter for cleaning is relatively high,
at least one of remaining vacuum cleaners of the vacuum cleaners is a low vacuum cleaner, an allowable height allowing the low vacuum cleaner to enter for cleaning is lower than the allowable height allowing the high vacuum cleaner to enter, and
a high cleaning route which is a cleaning route acquired by the cleaning route acquisition unit of the high vacuum cleaner is different from a low cleaning route which is a cleaning route acquired by the cleaning route acquisition unit of the low vacuum cleaner.

3. The system according to claim 2, wherein
the estimated map acquisition unit of the high vacuum cleaner creates a high movement map that is the self-position estimation map corresponding to a measurement target space of the position sensor attached to the high vacuum cleaner, and
the estimated map acquisition unit of the low vacuum cleaner creates a low movement map that is the self-position estimation map corresponding to a measurement target space of the position sensor attached to the low vacuum cleaner.

4. The system according to claim 2, further comprising a cleaning route creation unit that creates at least one of a high cleaning route based on a high plan map which is the route planning map showing an area where the high vacuum cleaner can reach and a low cleaning route based on a low plan map which is the route planning map showing an area where the low vacuum cleaner can reach.

5. The system according to claim 4, further comprising a plan map creation unit that creates the high plan map based on data from the position sensor included in the high vacuum cleaner and the low plan map based on data from the position sensor included in the low vacuum cleaner.

6. The system according to claim 2, further comprising:
a plan map acquisition unit that acquires the route planning map; and
an information presentation unit that displays a cleaning route or an actual cleaning route on which cleaning has been actually performed and the route planning map in a superimposed state.

7. A non-transitory computer-readable storage medium storing a cleaning control program for controlling a vacuum cleaner that autonomously runs in a predetermined space and performs cleaning and causing a computer to implement an estimated map acquisition unit that acquires a self-position estimation map corresponding to a measurement target space,
a cleaning route acquisition unit that acquires a cleaning route created along a running surface based on a route planning map having a shape different from a shape of the self-position estimation map,
a self-position estimation unit that acquires, from a position sensor, a positional relationship between the vacuum cleaner and an object present in a two-dimensional measurement target space along the running surface of the vacuum cleaner and estimates a self-position using the acquired positional relationship and the self-position estimation map, and
a running controller that causes the vacuum cleaner to run along the cleaning route based on the self-position estimated by the self-position estimation unit.
